(19) United States
(12) Patent Application Publication
(10) Pub. No.: US 2004/0005929 A1
(43) Pub. Date: Jan. 8, 2004

(54) Star flexible coupling

(76) Inventors: Frank N. Piasecki, Haverford, PA (US); Frederick W. Piasecki, Haverford, PA (US); Dezi Folenta, Lincoln Park, NJ (US)

Correspondence Address: Willard M. Hanger, P.O. Box 3078, Hilton Head Island, SC, 29928-0078, US

(21) Appl. No.: 10/188,253

(22) Filed: Jul. 3, 2002

(51) Int. Cl. F16D 3/56; F16D 3/64; F16D 3/78

(52) U.S. Cl. 464/98

(57) ABSTRACT

A flexible coupling for coupling together a pair of axially misaligned shafts of which the respective ends of the shafts retainably fit within a hub within the interior of which the longitudinal axes of the shafts meet at a common point. A plurality of arms extend radially outwardly along the hub and a portion of the hub adjacent each and extend toward each other into the interior of the hub into contact with a bearing contained within the hub of the common point, whereby ends of each respective shaft and hub retaining portion are movable relative to one another.

### FIELD OF THE INVENTION

This invention relates to a flexible coupling for connecting a driving rotatable shaft to a driven rotatable shaft allowing limited relative misalignment of these shafts.

### BACKGROUND OF THE INVENTION

Various prior art patents relating to flexible couplings, particularly U.S. Pat. No. 3,864,940, utilize a hub in which the ends of the respective shafts are retained with a plurality of outwardly extending tapered arms extending radially around the periphery of the hub. This invention involves a coupling having a foreshortened hub around the periphery of which tapered arms extend outwardly which is lighter and more reliable than prior known flexible couplings and transmits higher torques and allows greater shaft misalignment than conventional flexible couplings.

### BRIEF SUMMARY OF THE INVENTION

It is an object of the invention to provide a coupling which connects together axially a pair of misaligned shafts.

It is another object of the invention to provide a coupling which permits a powered rotatable shaft to provide a high degree of torque to an axially misaligned driven rotatable shaft even with any one structural element damaged.

It is another object of the invention to provide a light and simple coupling which connects together axially misaligned shafts.

The invention achieves its objectives in a coupling having a circumferentially extending hub into the opposite ends of which the respective ends of each of the pair of misaligned shafts are retainably fitted with a plurality of outwardly tapered arms extending radially outwardly of the hub in axial alignment along its length with the hub opposite ends and arms being supported by a bearing within the interior of the hub.

### BRIEF DESCRIPTION OF THE DRAWINGS

FIG. 1 is an end view of the coupling.

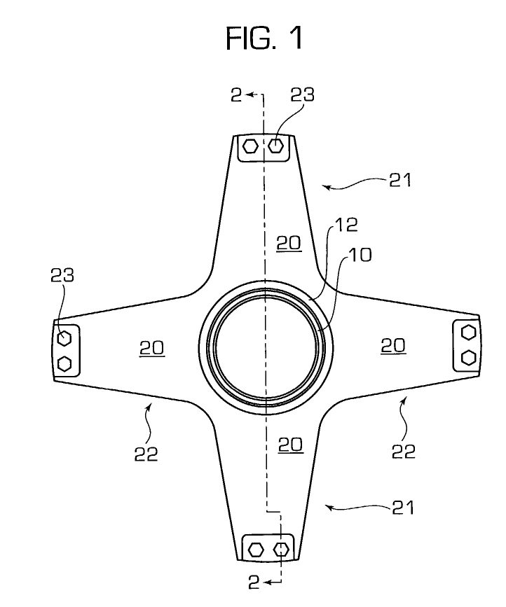

FIG. 2 is a cross section of the coupling along section 2-2 of FIG. 1.

### DETAILED DESCRIPTION OF THE INVENTION

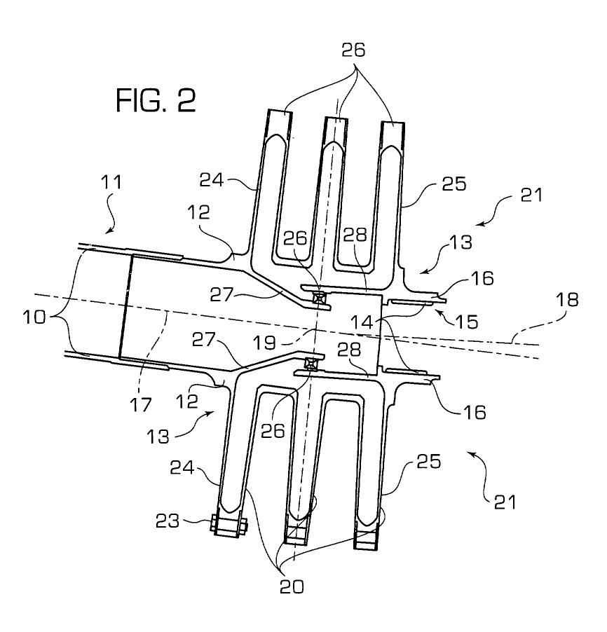

As best seen in FIG. 2, the end 10 of a driving rotatable shaft 11 is bolted to a forward end portion 12 of a hub 13 extending lengthwise of the coupling and the end 14 of a rotatable driven shaft 15 is shrunk-fit or otherwise fastened within the rearward end portion 16 of the hub 13. Axial misalignment of the driving shaft 11 and the driven shaft 15 angularly disposes the longitudinal axis 17 of the driving shaft 14 and the longitudinal axis 18 of the driven shaft so they meet at a common point 19 within the interior of the hub 13. A plurality (three), illustrated in FIG. 2., of arms 20 extend outwardly of and are spaced apart axially along the length of the hub 13 with the plurality of arms arranged in sets 21, 22 in which the axially arranged arms of each set extend from the hub 13 oppositely of each other and the arms of the respective sets 21, 22 are perpendicular to each other with the arms in the two sets 21, 22 located within outermost arms 24, 25. Each of the arms 20 tapers along its length from the hub 13 with each tapered outer end secured by a bolt 23. A roller bearing 26 is located at the common point 19 within the interior central portion of the hub 13. A conical shaped extension 27 of the inner forward end portion 12 of the hub 13 adjacent the outermost arms 24 and a similarly shaped extension 28 of the rearward end portion 16 of the hub 13 extend toward each other into the interior of the hub 13 into supporting contact with the roller-bearing 26.

It should be understood that the foregoing disclosure involves a preferred and typical embodiment of the invention and that numerous modifications or alterations thereof would be obvious and be made by those of normal skill in the art without departing from the spirit and spoke as set forth in the appendant claims.

What is claimed is:

1. A flexible coupling for coupling together a pair of axially misaligned shafts comprising:
a. A hub having opposite side ends each configured to retain an end of one shaft of said pair axially misaligned such that the respective longitudinal axes of said shaft pair meet at a common point within said hub,
b. a plurality of arms extending radially outwardly of and arranged axially along the length said hub,
c. a bearing contained within said hub at said common point and
d. said hub having a portion of each side end shaped to extend into the interior of said hub toward each other into contact with said bearing.

2. The flexible coupling of claim 1 wherein a pair of arms of said plurality of arms being the outermost of said plurality of arms and
a. said portion adjacent each end of said hub shaped to extend into said hub contacting being said outermost arm pairs of said plurality of arms

3. The flexible coupling of any one of claims 1-2 wherein said plurality of arms comprises two sets of arms extending outwardly of said hub with each set arranged axially along axes perpendicular to each other.

4. The flexible coupling of any one of claims 1-3 wherein the cross sectional dimension of said arms tapers from said hub along the length of said arms.

5. The flexible coupling of claim 4 wherein each outer end of said arms is secured by one or more bolts.
